(19) United States
(12) Patent Application Publication
(10) Pub. No.: US 2019/0282043 A1
(43) Pub. Date: Sep. 19, 2019

(54) Urine Receptacle Assembly

(71) Applicant: Eddie Luster, Fort Myers, FL (US)

(72) Inventor: Eddie Luster, Fort Myers, FL (US)

(21) Appl. No.: 15/920,933

(22) Filed: Mar. 14, 2018

(51) Int. Cl. A47K 11/12; B60R 15/04

(52) U.S. Cl. CPC A47K 11/12; B60R 15/04

(57) ABSTRACT

A urine receptacle assembly, for receiving urine while in a vehicle, includes a container that has a bottom wall, a top wall and a perimeter wall attached to and extending between the top and bottom walls to define a receiving space. A divider is mounted within the container and is attached to and extends downwardly from the top wall to the bottom to define a first portion and a second portion of the receiving space. A conduit is fluidly coupled to the container and extends upwardly from the container. The conduit receives urine and guides the urine into the container. A pump is in fluid communication with the conduit and directs fluid from the first portion to the second portion when the pump is actuated. A power input is electrically coupled to the pump and comprises a power plug that is electrically coupled to a power port.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention

### (2) Description of Related Art including information disclosed under 37 CFR 1.97 and 1.98.

The disclosure and prior art relates to urine receptacle devices and more particularly pertains to a new urine receptacle device for receiving urine while in a vehicle.

### BRIEF SUMMARY OF THE INVENTION

An embodiment of the disclosure meets the needs presented above by generally comprising a container that has a bottom wall, a top wall and a perimeter wall that is attached to and extends between the top wall and the bottom wall such that a receiving space is defined therein. The perimeter wall has a front side and a back side. A divider is mounted within the container. The divider is attached to and extends downwardly from the top wall to the bottom wall. The divider defines a first portion and a second portion of the receiving space. The first portion includes the front side and the second portion includes the back side. A conduit is fluidly coupled to the container. The conduit is configured to receive urine and guide the urine into the container. The conduit extends upwardly from the container. A pump is in fluid communication with the conduit. The pump directs fluid from the first portion to the second portion when the pump is turned on. A power input is electrically coupled to the pump and comprises a power plug that is configured to be electrically coupled to a power port of a vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of a urine receptacle assembly according to an embodiment of the disclosure.

FIG. 2 is a top side view of an embodiment of the disclosure.

FIG. 3 is a cross-sectional view of an embodiment of the disclosure taken along line 3-3 of FIG. 1.

FIG. 4 is a side view of an embodiment of the disclosure.

FIG. 5 is a schematic box diagram of an embodiment of the disclosure.

### DETAILED DESCRIPTION OF THE INVENTION

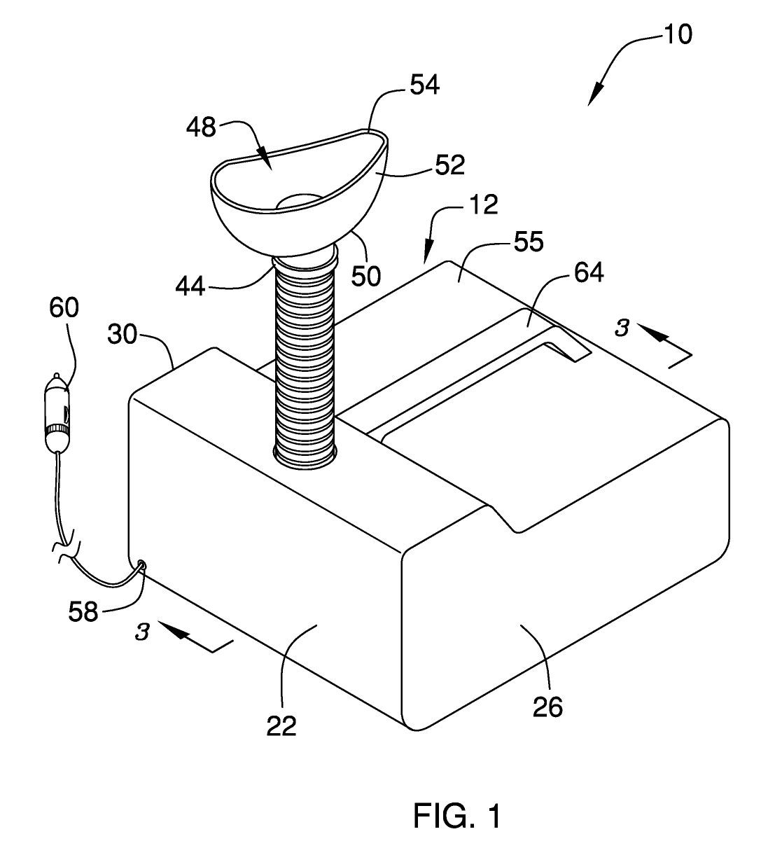

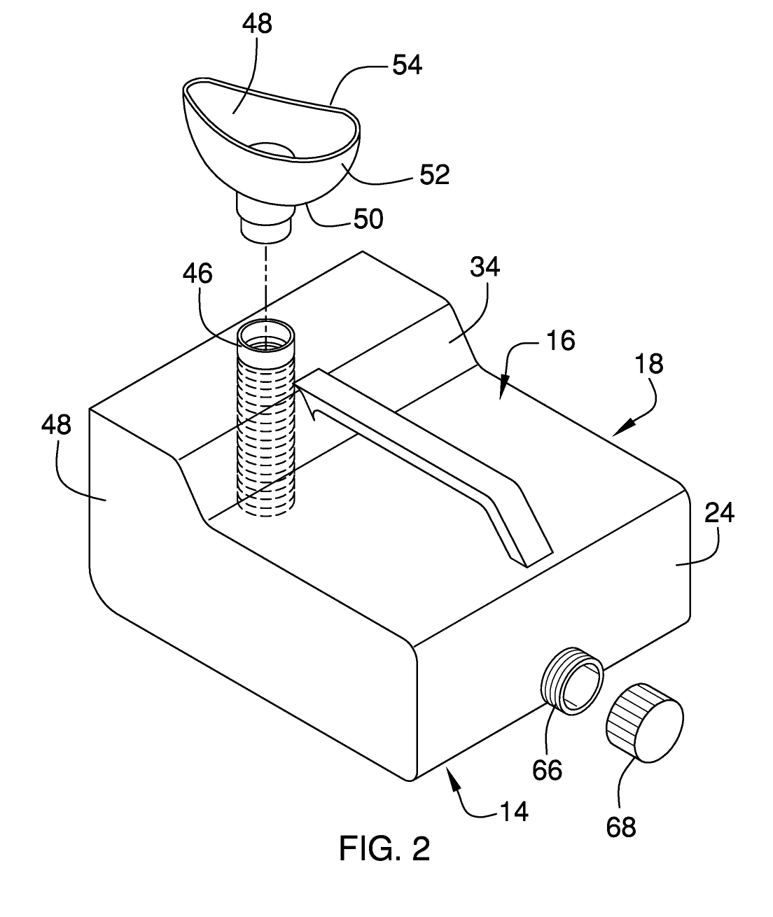

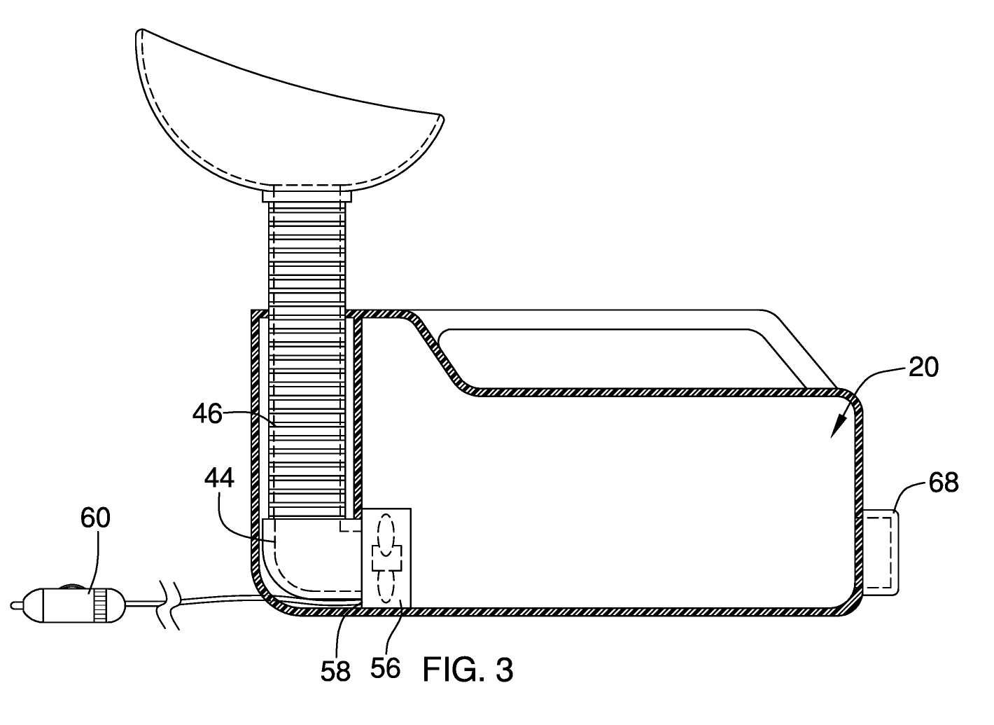

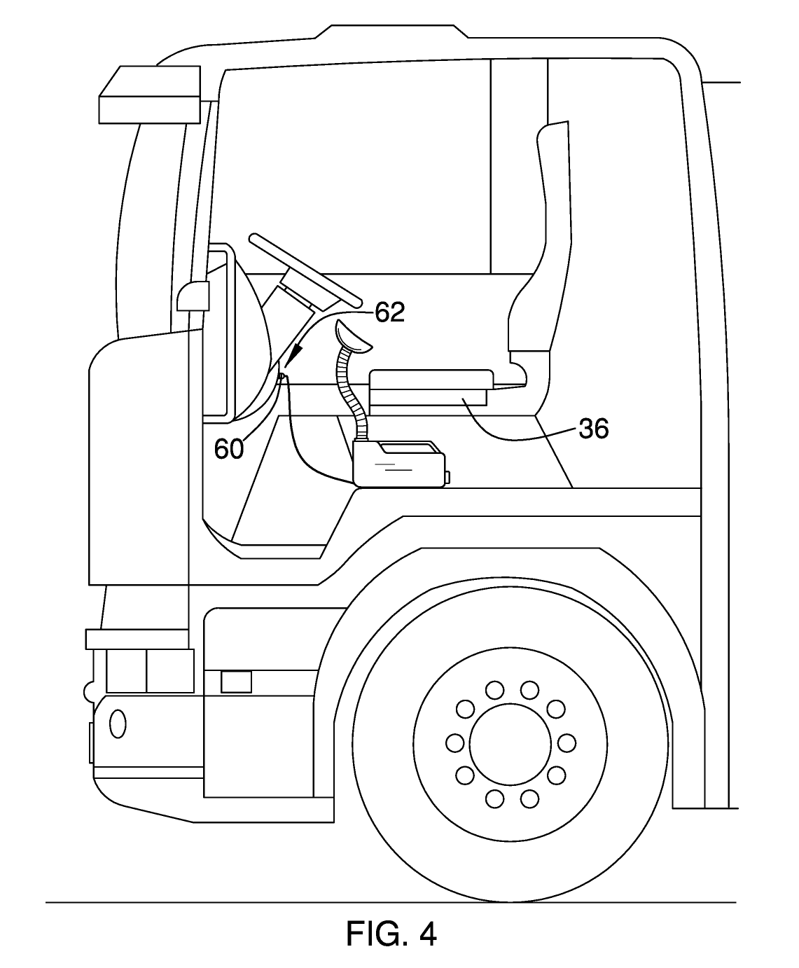

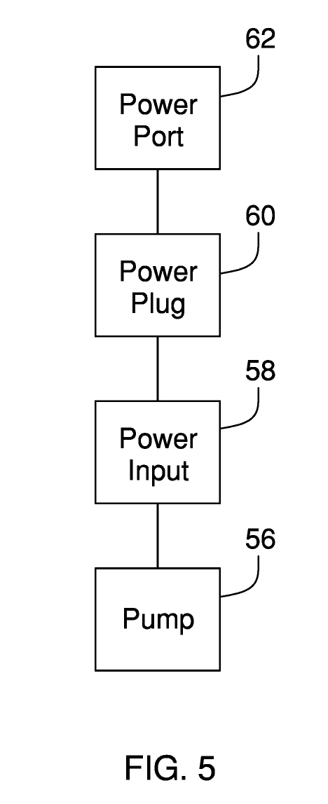

With reference now to the drawings, and in particular to FIGS. 1 through 5 thereof, a new urine receptacle device embodying the principles and concepts of an embodiment of the disclosure and generally designated by the reference numeral 10 will be described.

As best illustrated in FIGS. 1 through 5, the urine receptacle assembly 10 generally comprises a container 12 that has a bottom wall 14, a top wall 16 and a perimeter wall 18 that is attached to and extends between the top wall 14 and the bottom wall 12 such that a receiving space 20 is defined therein. The perimeter wall 18 has a front side 22, a back side 24, a first lateral side 26 and a second lateral side 28. The top wall 16 has a raised surface 30, a lowered surface 32 and a sloped surface 34 that slopes downwardly from the raised surface 30 toward the lowered surface 32. The raised surface 30 is adjacent to the front side 22 and the lowered surface 32 is adjacent to the back side 24 wherein the lowered surface facilitates the back side being positioned under a seat of the vehicle 36. The sloped surface 34 is positioned between a center point of the top wall 16 and the front side 22.

A divider 38 is mounted within the container 12 and is attached to and extends downwardly from the top wall 16 to the bottom wall 14. The divider 38 is perpendicular to the first 26 and second lateral walls 28 such that the divider 38 defines a first portion 40 and a second portion 42 of the receiving space 20. The first portion 40 includes the front side 22 and the second portion 42 includes the back side 24. The second portion 42 holds urine therein. The divider 38 is nearer to the front side 22 than the back side 24.

A conduit is included and receives urine and guides the urine into the container 12. The conduit includes a pipe 44 that is positioned in the first portion 40 and extends through the divider 38 such that the pipe 44 is in fluid communication with the second portion 42. A tube 46 is fluidly coupled to and extends upwardly from an aperture in the pipe 44. An upper end of the tube 46 extends outwardly from the container 12 from an opening in the top wall 16 adjacent to the front side 22. The tube 46 is extendable relative to the container 12 such that the tube 46 has an adjustable height. The tube 46 comprises a bendable material wherein the bendable material retains its shape when bent.

A receiving bowl 48 has a lower wall 50 and a peripheral wall 52 that extends upwardly therefrom. The lower wall 50 is attached to and in fluidly communication with the tube 46 opposite of the pipe 44. The peripheral wall 52 has a top edge 54 that defines an opening into the receiving bowl 48. The opening receives urine therein such that the urine flows into the tube 46, through the pipe 44 and into the second portion 42.

A pump 56 is in fluid communication with the conduit and directs fluid from the first portion 40 to the second portion 42 when turned on. A power input 58 is electrically coupled to the pump 56 and comprises a power plug 60 that is electrically coupled to a power port 62 of a vehicle.

A handle 64 is attached to and extends upwardly from the container 12. A drain 66 is fluidly coupled to the container 12 and is in fluid communication with the receiving space 20. The drain 66 is positioned on the back side 24 and adjacent to the bottom wall 14. A cap 68 is removably positioned on the drain 66 to close the drain 66 and may be threadably coupled thereon.

In use, the assembly is positioned in front of a vehicle seat 34. The tube 46 is extended and bent into a position such that the receiving bowl 48 is adjacent to a person's penis. The person then may urinate into the receiving bowl 48. The urine flows into the tube 46, through the pipe 44 and into the second portion 42 of the receiving space 22. To empty the receiving space 22, the drain 66 is positioned over a toilet and the cap 68 is removed to allow the urine to drain outwardly from the receiving space 22. The container 12 may be stored under a vehicle seat 34 when not being used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable urinal assembly configured to be used while inside of a vehicle, said assembly comprising:
a container having a bottom wall, a top wall and a perimeter wall being attached to and extending between said top wall and said bottom wall such that a receiving space is defined therein, said perimeter wall having a front side and a back side;
a divider being mounted within said container, said divider being attached to and extending downwardly from said top wall to said bottom wall, said divider defining a first portion and a second portion of said receiving space, said first portion including said front side and said second portion including said back side;
a conduit being fluidly coupled to said container, said conduit being configured for receiving urine and guiding the urine into said container, said conduit extending upwardly from said container;
a pump being in fluid communication with said conduit, said pump directing fluid from said first portion to said second portion when said pump is turned on; and
a power input being electrically coupled to said pump, said power input comprising a power plug configured to be electrically coupled to a power port of a vehicle.

2. The portable urinal assembly according to claim 1, wherein said top wall has a raised surface, a lowered surface and a sloped surface that slopes downwardly from said raised surface toward said lowered surface, said raised surface being adjacent to said front wall and said lowered surface being adjacent to said back wall, said sloped surface being positioned between a center point of said top wall and said front wall, said conduit being positioned on said raised surface.

3. The portable urinal assembly according to claim 1, wherein said divider is positioned nearer to said front side than said back side, said second portion being configured to hold urine.

4. The portable urinal assembly according to claim 1, wherein said conduit includes:
a pipe being positioned in said first portion and extending through said divider such that said pipe is in fluid communication with said second portion;
a tube being fluidly coupled to and extending upwardly from an aperture in said pipe, an upper end of said tube extending outwardly from said container from an opening in said top wall adjacent to said front side, said tube being extendable relative to said container such that said tube has an adjustable height; and
a receiving bowl having a lower wall and a peripheral wall that extends upwardly therefrom, said lower wall being attached to and in fluidly communication with said tube opposite of said pipe, said peripheral wall having a top edge that defines an opening into said receiving bowl, said opening receiving urine therein such that said urine flows into said tube, through said pipe and into said second portion.

5. The portable urinal assembly according to claim 4, wherein said tube comprises a bendable material.

6. The portable urinal assembly according to claim 4, wherein said bendable material retains its shape when bent.

7. The portable urinal assembly according to claim 1, further including a handle being attached to and extending upwardly from said container.

8. The portable urinal assembly according to claim 1, further including a drain being fluidly coupled to said container and being in fluid communication with said receiving space, said drain being positioned on said back side and adjacent to said bottom wall.

9. The portable urinal assembly according to claim 8, further including a cap being removably positioned on said drain to close said drain, said cap being threadably coupled to said drain.

10. A portable urinal assembly configured to be used while inside of a vehicle, said assembly comprising:
a container having a bottom wall, a top wall and a perimeter wall being attached to and extending between said top wall and said bottom wall such that a receiving space is defined therein, said perimeter wall having a front side, a back side, a first lateral side and a second lateral side, said top wall having a raised surface, a lowered surface and a sloped surface that slopes downwardly from said raised surface toward said lowered surface, said raised surface being adjacent to said front wall and said lowered surface being adjacent to said back wall to facilitate said rear wall being positioned under a seat of the vehicle, said sloped surface being positioned between a center point of said top wall and said front wall;
a divider being mounted within said container, said divider being attached to and extending downwardly from said top wall to said bottom wall, said divider being perpendicular to said first and second lateral walls such that said divider defines a first portion and a second portion of said receiving space, said first portion including said front side and said second portion including said back side, said divider being nearer to said front side than said back side, said second portion being configured to hold urine;
a conduit for receiving urine and guiding said urine into said container, said conduit including:
a pipe being positioned in said first portion and extending through said divider such that said pipe is in fluid communication with said second portion;
a tube being fluidly coupled to and extending upwardly from an aperture in said pipe, an upper end of said tube extending outwardly from said container from an opening in said top wall adjacent to said front side, said tube being extendable relative to said container such that said tube has an adjustable height, said tube comprising a bendable material, said bendable material retaining its shape when bent;
a receiving bowl having a lower wall and a peripheral wall that extends upwardly therefrom, said lower wall being attached to and in fluidly communication with said tube opposite of said pipe, said peripheral wall having a top edge that defines an opening into said receiving bowl, said opening receiving urine therein such that said urine flows into said tube, through said pipe and into said second portion;
a pump being in fluid communication with said conduit, said pump directing fluid from said first portion to said second portion when said pump is turned on;
a power input being electrically coupled to said pump, said power input comprising a power plug configured to be electrically coupled to a power port of a vehicle;
a handle being attached to and extending upwardly from said container;
a drain being fluidly coupled to said container and being in fluid communication with said receiving space, said drain being positioned on said back side and adjacent to said bottom wall; and
a cap being removably positioned on said drain to close said drain, said cap being threadably coupled to said drain.
